(19) United States
(12) Patent Application Publication
(10) Pub. No.: US 2015/0123917 A1
(43) Pub. Date: May 7, 2015

(54) TOUCH DISPLAY DEVICE

(71) Applicant: Innolux Corporation, Miao-Li County (TW)

(72) Inventors: Jian-Cheng Chen, Miao-Li County (TW); Huei-Ying Chen, Miao-Li County (TW)

(21) Appl. No.: 14/506,802

(22) Filed: Oct. 6, 2014

(30) Foreign Application Priority Data
Nov. 5, 2013 (TW) 102140111

(51) Int. Cl. G06F 3/041; G06F 3/045

(52) U.S. Cl. CPC G06F 3/041; G06F 3/045
USPC 345/173

(57) ABSTRACT

A touch display device is provided. The touch display device comprises a first substrate, a second substrate opposite to the first substrate, a display medium layer, a cover layer, and a first touch electrode layer disposed between the first substrate and the cover layer. The second substrate is disposed between the cover layer and the first substrate. The thickness of the first touch electrode layer is between (1400 Å×N)×1.1 and (1400 Å×N)×0.9, where N is one of a positive integer of 1 to 5.

This application claims the benefit of Taiwan application Serial No. 102140111, filed Nov. 5, 2013, the subject matter of which is incorporated herein by reference.

### BACKGROUND

1. Technical Field

The disclosure relates in general to a touch display device, and more particularly to a touch display device having a touch electrode layer with specific thickness.

2. Description of the Related Art

With improvement of technology, touch display devices have been widely used in smart phones, tablet computers, notebook computers and other portable electronic devices. Touching sensitivity of the touch display device has great relationship with the sheet resistance (Rs) of the display device. Touch display devices with large size usually need smaller sheet resistance for maintaining greater touch sensitivity. Generally, the thickness of the conductive layer in touch display device is increased to reduce the sheet resistance.

However, the increased thickness of the conductive layer leads to reduce the transmittance of light, such that users will easily see the internal circuits when viewing the touch display device, which affects the display quality of the touch display device.

### SUMMARY

The disclosure is directed to a touch display device. When lights penetrate through the touch electrode layer, they would maintain greater transmittance by maintaining the touch electrode layer with specific thickness, such that the display quality of the touch display device will be improved.

According to one embodiment, a touch display device is provided. The touch display device comprises a first substrate, a second substrate opposite to the first substrate, a display medium layer, a cover layer, and a first touch electrode layer disposed between the first substrate and the cover layer. The second substrate is disposed between the cover layer and the first substrate. The first touch electrode layer is disposed between the cover layer and the first substrate. A thickness of the first touch electrode layer is between (1400 Å×N)×1.1 and (1400 Å×N)×0.9, where N is one of a positive integer of 1 to 5.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 illustrates a touch display device in one embodiment according to the disclosure.

FIGS. 2A˜2G illustrate touch display devices in other embodiments according to the disclosure.

FIG. 3 illustrates the relationship between the transmittance/reflectance and the thickness of the touch electrode layer.

FIG. 4 illustrates the relationship between the transmittance and the thickness of the touch electrode layer.

FIG. 5 illustrates the CIE 1931 color chromaticity coordinates diagram of the reflected light under different thickness conditions of the touch electrode layer according to one embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiments are described in details with reference to the accompanying drawings. The identical elements of the embodiments are designated with the same reference numerals. Also, it is important to point out that the illustrations may not be necessarily drawn to scale, and that there may be other embodiments of the present disclosure which are not specifically illustrated. Thus, the specification and the drawings are regard as an illustrative sense rather than a restrictive sense.

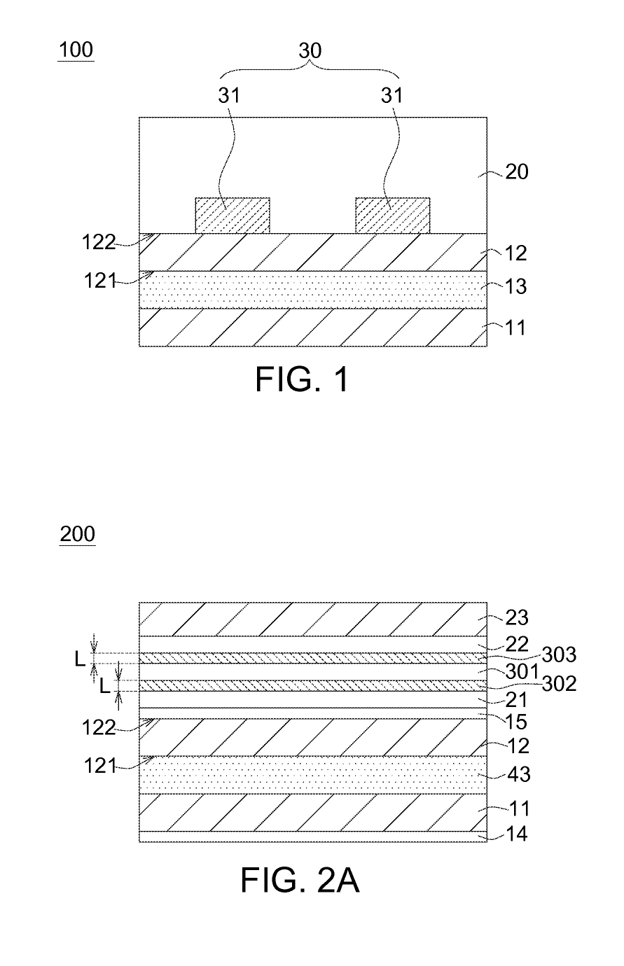

FIG. 1 illustrates a touch display device 100 in one embodiment according to the disclosure. In order to facilitate understanding of the technical contents of the disclosure, some elements will be omitted in the following embodiments and figures. As shown in FIG. 1, the touch display device 100 includes a first substrate 11, a second substrate 12, a display medium layer 13, a cover layer 20, and a touch electrode layer 30. The second substrate 12 is opposite to the first substrate 11. That is, the second substrate 12 faces the first substrate 11. The second substrate 12 is disposed between the cover layer 20 and the first substrate 11. The display medium layer 13 is disposed between the first substrate 11 and the second substrate 12. The cover layer 20 is disposed for coving the touch electrode layer 30, and the touch electrode layer 30 is disposed between the first substrate 11 and the cover layer 20. Besides, the cover layer 20 in the disclosure is not limited to a single-layer structure. In some embodiments, the cover layer 20 may be a composite structure with multi-layer material.

In one embodiment, the second substrate 12 has a first surface 121 facing the first substrate 11 and a second surface 122 opposed to the first surface 121. The cover layer 20 is disposed on the second surface 122 of the second substrate 12.

The first substrate 11, the second substrate 12 and the display medium layer 13 may be used to display a frame image. The touch electrode layer 30 may be used to sense the touch signal, such that the touch positions will be detected. The touch electrode layer 30 may include coplanar touch electrode patterns. In another embodiment, the touch electrode layer 30 may include touch electrode patterns with bridge structure.

In one embodiment, the touch display device 100 may be a liquid crystal display (LCD). That is, the display medium layer 13 may be a liquid crystal layer. The first substrate 11 may be such as a thin film transistor substrate, and the second substrate 12 may be such as a color filter substrate. Each of the first substrate 11 and the second substrate 12 may include a polarizing plate (not shown) disposed opposed to the liquid crystal layer. In another embodiment, a color filter layer and a thin film transistor may both be disposed on the first substrate 11 or the second substrate 12.

However, the disclosure does not be limited thereto. In another embodiment, the display medium layer 13 may be an organic light-emitting layer. In one embodiment, the first substrate 11 may be such as a thin film transistor substrate, and the second substrate 12 may be such as a glass substrate. In another embodiment, the second substrate 12 may be such as a color filter substrate.

As shown in FIG. 1, the touch electrode layer 30 may include a plurality of patterned electrodes 31. A material of the patterned electrodes 31 of the touch electrode layer 30 may include, for example, indium tin oxide (ITO), indium zinc oxide (IZO), indium tin zinc oxide (ITZO), indium gallium zinc oxide (IGZO), aluminum zinc oxide (ZnO), aluminum zinc oxide (AZO) or gallium zinc oxide (GZO). A refractive index of the patterned electrode 31 of the embodiments above is between 1.7 and 2.3 (with light wavelength in the range of 400-700 nm). A thickness of patterned electrode 31 of the touch electrode layer may be between (1400 Å×N)×1.1 and (1400 Å×N)×0.9, where N is one of a positive integer of 1 to 5 (included the positive integers 1 and 5). In another embodiment, the thickness of the patterned electrode 31 may be between (1400 Å×N)×1.05 and (1400 Å×N)×0.95, where N is one of a positive integer of 1 to 5 (included the positive integers 1 and 5). In still another embodiment, N is one of a positive integer of 2 to 4 (included the positive integers 2 and 4).

Besides, a refractive index of the cover layer 20 in one embodiment of the disclosure is between 1.45 and 1.65 (with light wavelength in the range of 400-700 nm). In another embodiment of the disclosure, the refractive index of the cover layer 20 is between 1.48 and 1.6. Since the cover layer 20 in the disclosure may be a single-layer structure or a composite structure, the refractive index of the cover layer 20 in the disclosure refers to the refractive index of cover layer 20 with single-layer structure, or the overall refractive index of cover layer 20 with composite structure. The refractive index of the touch electrode layer 30 of the touch display device 100 is between 1.7 and 2.3, but the disclosure is not limited thereto. In some embodiments, the cover layer 20 may be a glass layer, an adhesive layer, a polarizing plate or a hard coated (HC) layer for protecting the touch electrode layer 30 inside. The adhesive layer is such as a pressure sensitive adhesive (PSA).

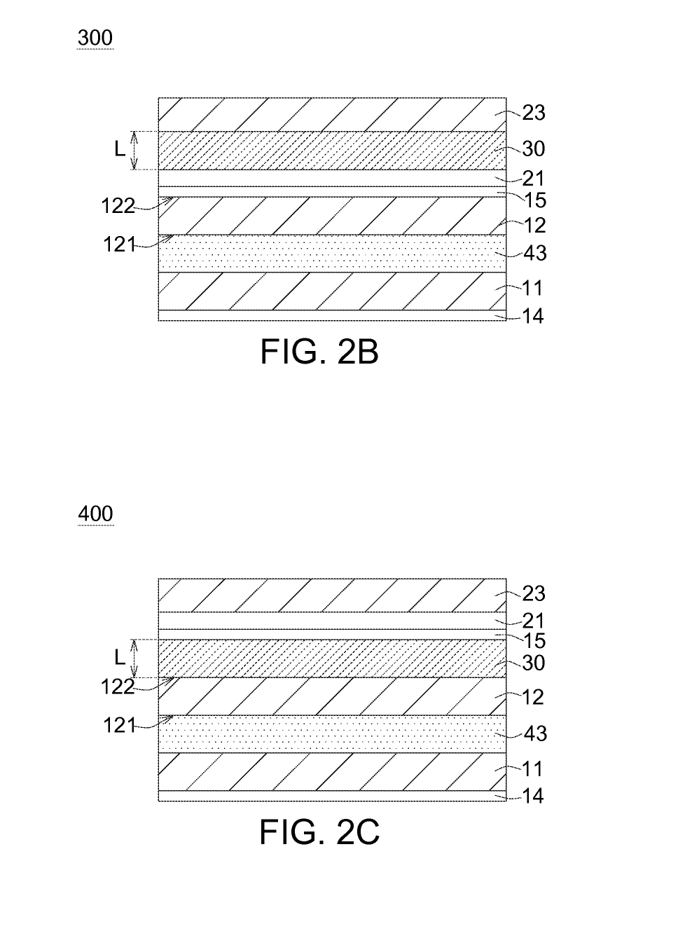

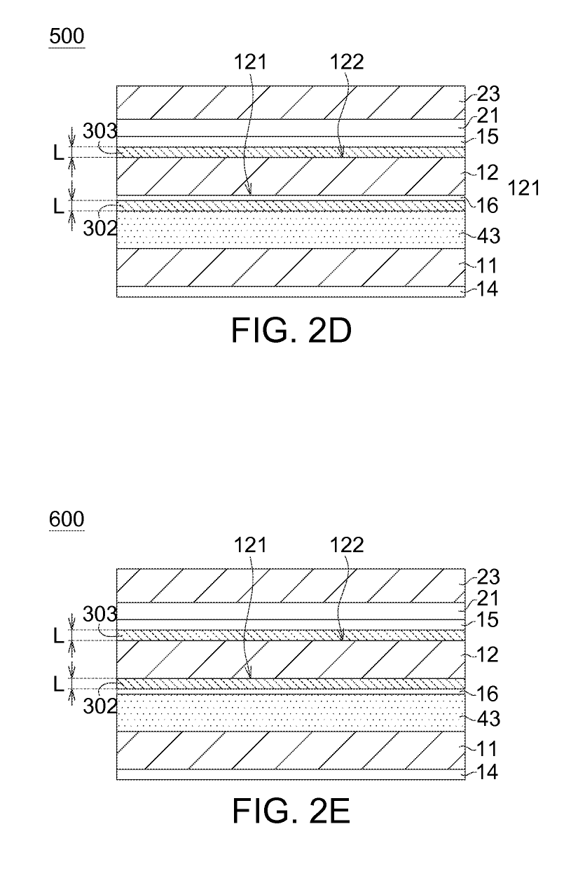

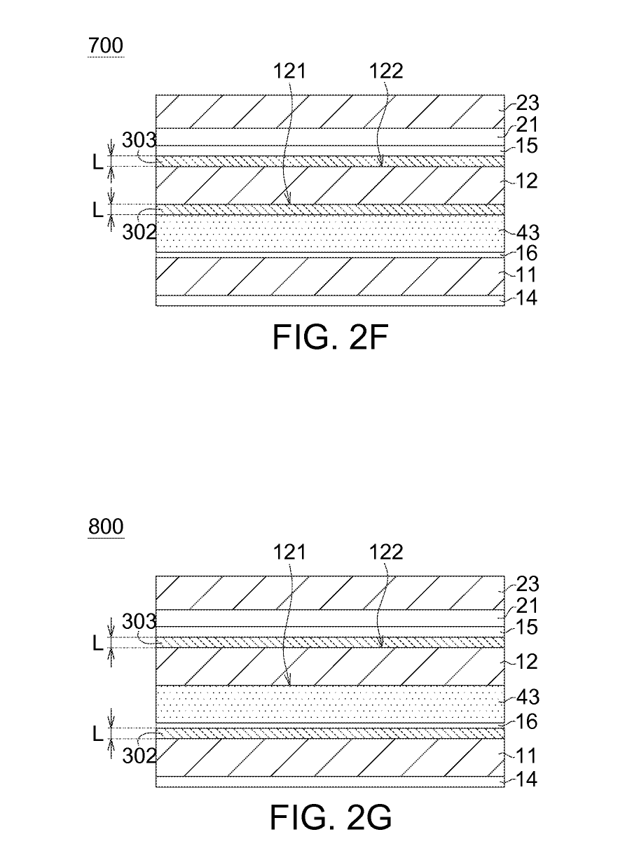

FIGS. 2A˜2G illustrate touch display devices in other embodiments according to the disclosure. Same or similar elements will be illustrated in the same reference numbers. It should be noted that although the following embodiments take liquid crystal display panels (having a first substrate 11, a second substrate 12 and a liquid crystal layer 43) as examples, the disclosure is not limited thereto. In other embodiments, the touch display device may be such as an organic light-emitting display (OLED). Besides, the cover layer may be a single-layer structure or a composite structure, and the cover layer may be made of a material with the refractive index between 1.45 and 1.65 or between 1.48 and 1.6. The touch electrode layer may include a plurality of pattered electrodes. However, the pattered electrodes will be omitted in the following description and the figures for the convenience of explanation.

As shown in FIG. 2A, the touch display device 200 is such as an Out-Cell touch display device including a first substrate 11, a second substrate 12 and a liquid crystal layer 43 disposed between the first substrate 11 and the second substrate 12. In this embodiment, the touch display device 200 further includes a first polarizing plate 14 and a second polarizing plate 15. The first substrate 11, the second substrate 12 and the liquid crystal layer 43 are disposed between the first polarizing plate 14 and the second polarizing plate 15.

In this embodiment, the touch display device 200 includes a first touch electrode layer 302, a second touch electrode layer 303 and a base layer 301. The base layer 301 is disposed on a second surface 122 of the second substrate 12. The first touch electrode layer 302 and the second touch electrode layer 303 are disposed on the upper side and the lower side of the base layer 301 respectively. The base layer 301 may be a glass or soft substrate, such as polyethylene terephthalate (PET) substrate. The first touch electrode layer 302 may be disposed on the second polarizing plate 15 by a first adhesive layer 21. The first touch electrode layer 302 may be a signal transmission layer, and the second electrode layer 303 may be a signal receiving layer; or the first touch electrode layer 302 may be a signal receiving layer, and the second electrode layer 303 may be a transmission signal layer. A glass layer 23 may be disposed on the second touch electrode layer 303 by a second adhesive layer 22. That is, the glass layer 23 and the second adhesive layer 22 may be a cover layer, and the base layer 301 (and the first touch electrode layer 302, second touch electrode 303) is disposed between the second substrate 12 and the cover layer (the glass layer 23 and the second adhesive layer 22). An electrode thickness L of the first touch electrode layer 302 or the second touch electrode layer 303 may be between (1400 Å×N)×1.1 and (1400 Å×N)×0.9, where N is one of a positive integer of 1 to 5. In another embodiment, the thickness L of the first touch electrode layer 302 or the second touch electrode layer 303 may be between (1400 Å×N)×1.05 and (1400 Å×N)×0.95, where N is one of a positive integer of 1 to 5. In still another embodiment, N may be one of a positive integer of 2 to 4.

As shown in FIG. 2B, the touch display device 300 is such as an One Glass Solution (OGS) touch display device. This is, a glass substrate with touch sensing functions is disposed on the display panel. The touch display device 300 includes a first substrate 11, a second substrate 12 and a liquid crystal layer 43 disposed between the first substrate 11 and the second substrate 12. In this embodiment, the touch display device 300 further includes a first polarizing plate 14 and a second polarizing plate 15. The first substrate 11, the second substrate 12 and the liquid crystal layer 43 are disposed between the first polarizing plate 14 and the second polarizing plate 15.

In this embodiment, a first adhesive layer 21 is between the touch electrode layer 30 and the second substrate 12. That is, the touch electrode layer 30 may be disposed on the second surface 122 of the second substrate 12 by the first adhesive layer 21. For example, the touch electrode layer 30 may be disposed on the second polarizing plate 15 by the first adhesive layer 21. A glass layer 23 may be used as a cover layer, and the touch electrode layer 30 may directly contact the glass layer 23. The touch electrode layer 30 in this embodiment may be a coplanar-electrode structure with both functions of signal transmission (Tx) and signal receiving (Rx). In another embodiment, the touch electrode 30 may be designed with a bridge structure of electrodes. That is, a bridge design (not show in the figure) is disposed at the intersection of signal transmission and signal receiving. The glass layer 23 is disposed on the touch electrode layer 30, and the touch electrode layer 30 can be made directly on the glass layer 23, and then attached on the display panel by the first adhesive layer 21.

Similarly, an electrode thickness L of the touch electrode layer 30 may be between (1400 Å×N)×1.1 and (1400 Å×N)×0.9, where N is one of a positive integer of 1 to 5. In another embodiment, the thickness L of the touch electrode layer 30 may be between (1400 Å×N)×1.05 and (1400 Å×N)×0.95, where N is one of a positive integer of 1 to 5. In still another embodiment, N may be one of a positive integer of 2 to 4.

As shown in FIG. 2C, the touch display device 400 is such as an On-cell touch display device. The touch display device 400 includes a first substrate 11, a second substrate 12 and a liquid crystal layer 43 disposed between the first substrate 11 and the second substrate 12. In this embodiment, the touch display device 400 further includes a first polarizing plate 14 and a second polarizing plate 15. The first substrate 11, the second substrate 12 and the liquid crystal layer 43 are disposed between the first polarizing plate 14 and the second polarizing plate 15. The difference from the touch display devices 200 and 300 above is that the position of the touch electrode layer 30.

As shown in FIG. 2C, the touch electrode 30 is disposed between the first polarizing plate 14 and the second polarizing plate 15. In this embodiment, the touch electrode 30 is disposed between the second polarizing plate 15 and the second substrate 12. A glass layer 23 is disposed on the second polarizing plate 15 by a first adhesive layer 21. The second polarizing plate 15, the first adhesive layer 21 and the glass layer 23 may be used as a cover layer of the touch electrode layer 30. Similarly, an electrode thickness L of the touch electrode layer 30 may be between (1400 Å×N)×1.1 and (1400 Å×N)×0.9, where N is one of a positive integer of 1 to 5. In another embodiment, the thickness L of the touch electrode layer 30 may be between (1400 Å×N)×1.05 and (1400 Å×N)×0.95, where N is one of a positive integer of 1 to 5. In still another embodiment, N may be one of a positive integer of 2 to 4.

FIGS. 2D˜2G illustrate In-Cell touch display devices in different embodiments according to the disclosure. In these embodiments, the touch display device (500, 600, 700, 800) includes a first substrate 11, a second substrate 12 and a liquid crystal layer 43, a first polarizing plate 14, a second polarizing plate 15 and a color filter layer 16. The color filter layer 16 and the liquid crystal layer 43 are disposed between the first substrate 11 and the second substrate 12. The first substrate 11, the second substrate 12, the color filter layer 16 and the liquid crystal layer 43 are disposed between the first polarizing plate 14 and the second polarizing plate 15.

Besides, a first touch electrode layer 302 and a second touch electrode layer 303 are included in the embodiments illustrated in FIG. 2D to FIG. 2G. The first touch electrode layer 302 and the second touch electrode layer 303 are separated with each other. In one embodiment, the first touch electrode layer 302 may be disposed between the first substrate 11 and a second surface 122 of the second substrate 12. For example, the first touch electrode layer 302 may be disposed on a first surface 121 of the second substrate 12, or disposed between the second surface 122 of the second substrate 12 and the liquid crystal layer 43. In the embodiments illustrated in FIGS. 2D˜2G, the second touch electrode layer 303 is disposed between the second polarizing plate 15 and the second substrate 12. The first touch electrode layer 302 and the second touch electrode layer 303 may be used as signal transmission electrodes or signal receiving electrodes to detect touch signals.

As shown in FIG. 2D, the first touch electrode layer 302 of the touch display device 500 is disposed between the color filter layer 16 and the first substrate 11, but the disclosure is not limited thereto. As shown in FIG. 2E, the first touch electrode layer 302 of the touch display device 600 may also be disposed between the color filter layer 16 and the second substrate 12.

As shown in FIG. 2F, in another embodiment, the color filter layer 16 of the touch display device 700 may be disposed on the first substrate 11. In this embodiment, the first touch electrode layer 302 is disposed between the second substrate 12 and the color filter layer 16, and the first touch electrode layer 302 may be designed to integrate with common electrodes on the second substrate 12. As shown in FIG. 2G, in still another embodiment, the color filter layer 16 and the first touch electrode layer 302 of the touch display device 800 may both be disposed on the first substrate 11. In this embodiment, the first touch electrode layer 302 may be designed to integrate with driving electrodes or common electrodes of the touch display device 800.

In the designed structures of the touch display device with In-Cell touch electrode (such as the first touch electrode 302) illustrated in FIGS. 2D˜2G, common electrodes or pixel electrodes of the touch display device (500, 600, 700, 800) may be used as touch electrodes to detect the touch action during the blanking time of displaying scanning. In another embodiment, other touch electrodes can be disposed. When the first touch electrode layer 302 and the second touch electrode layer 303 have an electrode thickness L between (1400 Å×N)×1.1 and (1400 Å×N)×0.9, where N is one of a positive integer of 1 to 5, the touch display device can have great display quality. Further, in another embodiment, N may be one of a positive integer of 2 to 4.

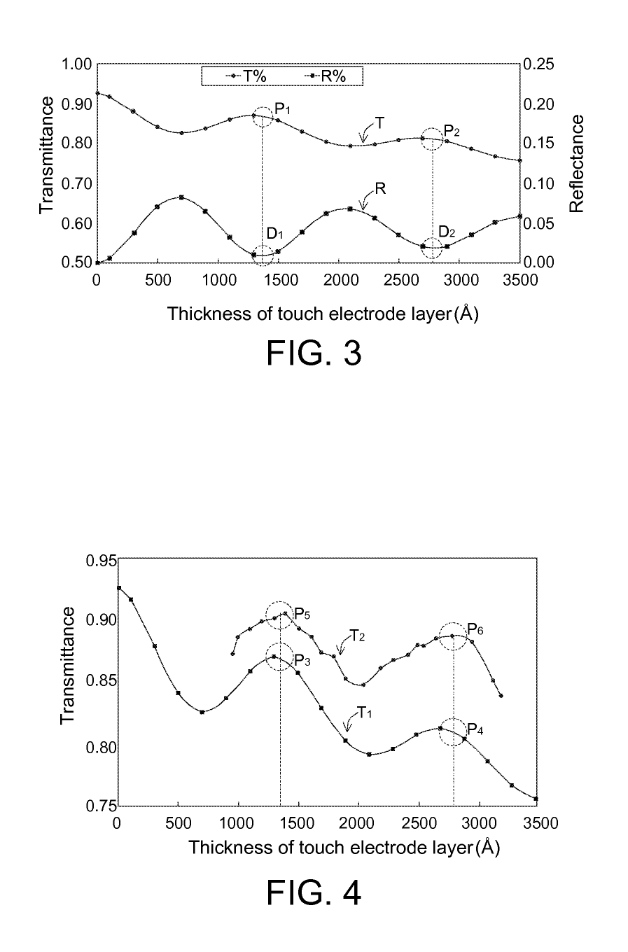

FIG. 3 illustrates the relationship between the transmittance/reflectance and the thickness of the touch electrode layer. Curve T represents the relationship between the transmittance and the thickness of the touch electrode layer, and Curve R represents the relationship between the reflectance and the thickness of the touch electrode layer.

As shown, the overall transmittance shows a downward trend as the thickness of the touch electrode layer increases. However, curve T shows that significant relative peak values P1 and P2 appear when the thickness of the touch electrode layer is about 1400 Å and 2800 Å. That is, the transmittance has relative high value at the peak P1 and peak P2. However, the reflectance does not show significant increase or decrease as the thickness of the touch electrode layer increases or decreases. But curve R shows that relative wave troughs D1 and D2 appear when the thickness of the touch electrode layer is about 1400 Å and 2800 Å. That is, at the relative wave troughs D1 and D2, the reflectance of which the electrode reflects lights from outside is relative low. As such, when the thickness of the touch electrode layer is about an integer multiple of 1400 Å, the transmittance is relative high (achieves the peak value) and the reflectance is relative low (achieves the wave trough value), such that lights have greater overall transmitting performance in the touch electrode layer.

FIG. 4 illustrates the relationship between the transmittance and the thickness of the touch electrode layer. Curve T1 is illustrated from the transmittance data obtained by simulating that the touch electrode layer is disposed between a display panel and a cover layer with refraction rate about 1.5; Curve T2 is illustrated from the transmittance data obtained by actual situation that the touch electrode layer is disposed between a display panel and a cover layer with refraction rate about 1.5.

As shown, curve T1 shows significant relative peak values P3 and P4 appear when the thickness of the touch electrode layer is about 1400 Å and 2800 Å. Similarly, curve T2 shows significant relative peak values P5 and P6 appear when the thickness of the touch electrode layer is about 1400 Å and 2800 Å. Besides, the decreasing degree of the transmittance obtained from the transmittance data in the actual situation (as shown in curve T2) is slighter than that in the simulation (as shown in curve T1) as the touch electrode layer increases. However, in both curve T1 and curve T2, relative peak value of the transmittance is shown when the thickness of the electrode is about 1400 Å and 2800 Å. That is, whether in simulation or in the actual situation, lights have greater transmission performance in the touch electrode layer when the thickness of the touch electrode layer is about 1400 Å and 2800 Å.

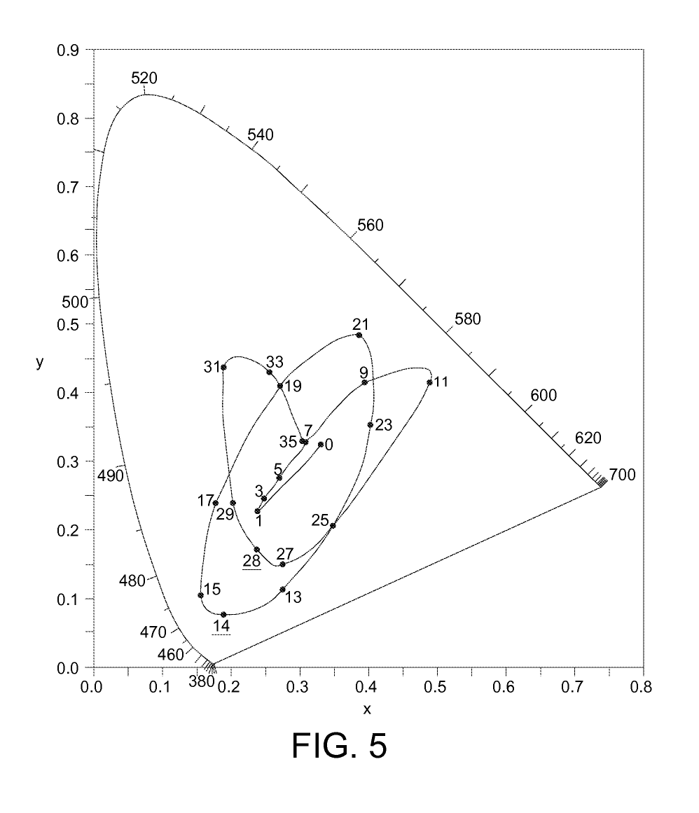

FIG. 5 illustrates the CIE 1931 color chromaticity coordinates diagram of the reflected light under different thickness conditions of the touch electrode layer according to one embodiment of the disclosure. In Table 1 and FIG. 5, conditions of different numbers correspond to electrode thickness of different touch electrode layers, which show different color coordinates (x, y) and reflectance. As shown in Table 1 and FIG. 5, the color dot of the reflected light is close to blue when the electrode thickness of the touch electrode layer is about 1400 Å and 2800 Å. Because the human eye is insensitivity to the blue color, similar to the color of the reflected light in the black matrix (BM) layer of the display device, which is close to the dark color, when the backlight of the display device is turned off, it is hard for users to observe the electrode patterns by the sensitivity to the color of the reflected light or the apparently different between the color of the reflected light and the black matrix layer, such that the quality of the touch display panel becomes greater.

Instead, the color dot of the reflected light is close to green when the electrode thickness of the touch electrode layer is about 900 Å or 2100 Å (corresponding to number 9, 21). Because human eyes are more sensitive to green which is more different from the color of the reflected light in the black matrix layer, it is easy to observe the electrode patterns when the backlight of the display device is turned off. Therefore, if the color of the reflected light of the electrode patterns is more desired to be close to the color of the reflected light in the black matrix layer, then it is ideal to choose the touch electrode layer with thickness about 1400 Å or 2800 Å.

TABLE 1

| | Electrode | | | |
|---|---|---|---|---|
| | thickness of the | | | |
| | touch electrode | | | |
| Number | layer (Å) | X | y | R % |
| 0 | 0 | 0.331 | 0.331 | 3.8 |
| 1 | 100 | 0.239 | 0.232 | 0.5 |
| 3 | 300 | 0.249 | 0.250 | 3.5 |
| 5 | 500 | 0.270 | 0.281 | 6.9 |
| 7 | 700 | 0.310 | 0.333 | 8.1 |
| 9 | 900 | 0.395 | 0.423 | 6.4 |
| 11 | 1100 | 0.488 | 0.422 | 3.2 |
| 13 | 1300 | 0.275 | 0.115 | 0.9 |
| 14 | 1400 | 0.189 | 0.076 | 0.8 |
| 15 | 1500 | 0.156 | 0.106 | 1.3 |
| 17 | 1700 | 0.178 | 0.244 | 3.7 |
| 19 | 1900 | 0.272 | 0.417 | 6.0 |
| 21 | 2100 | 0.387 | 0.492 | 6.6 |
| 23 | 2300 | 0.404 | 0.359 | 5.3 |
| 25 | 2500 | 0.348 | 0.209 | 3.3 |
| 27 | 2700 | 0.276 | 0.153 | 2.1 |
| 28 | 2800 | 0.238 | 0.175 | 2.0 |
| 29 | 2900 | 0.203 | 0.242 | 2.4 |
| 31 | 3100 | 0.190 | 0.445 | 3.6 |
| 33 | 3300 | 0.258 | 0.438 | 4.8 |
| 35 | 3500 | 0.305 | 0.335 | 5.1 |

According to the embodiments and the result of the experiment, the touch display device in the disclosure can make the light to maintain high transmittance and low reflectance when penetrating the touch electrode layer, such that the internal circuits of the touch display device can prevent from being seen by uses when users are watching the touch display device, and the display quality of the touch display device will be improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A touch display device, comprising:
a first substrate;
a second substrate opposite to the first substrate;
a display medium layer disposed between the first substrate and the second substrate;
a cover layer, wherein the second substrate is disposed between the cover layer and the first substrate; and
a first touch electrode layer disposed between the first substrate and the cover layer,
wherein a thickness of the first touch electrode layer is between (1400 Å×N)×1.1 and (1400 Å×N)×0.9, where N is one of a positive integer of 1 to 5.

2. The touch display device according to claim 1, wherein the thickness of the first touch electrode layer is between (1400 Å×N)×1.05 and (1400 Å×N)×0.95

3. The touch display device according to claim 1, wherein N is one of a positive integer of 2 to 4.

4. The touch display device according to claim 1, wherein a refractive index of the cover layer is between 1.45 and 1.65.

5. The touch display device according to claim 1, wherein a refractive index of the cover layer is between 1.48 and 1.6.

6. The touch display device according to claim 1, wherein the display medium layer is a liquid crystal layer.

7. The touch display device according to claim 1, wherein the display medium layer is an organic light-emitting layer.

8. The touch display device according to claim 1, wherein the first touch electrode layer is directly contacted to the cover layer, and an adhesive layer is disposed between the first touch electrode layer and the second substrate.

9. The touch display device according to claim 1, further comprising a first polarizing plate and a second polarizing plate, wherein the first substrate, the second substrate and the display medium layer are disposed between the first polarizing plate and the second polarizing plate, and the first touch electrode layer is disposed between the second polarizing plate and the second substrate.

10. The touch display device according to claim 1, further comprising:
a second touch electrode layer disposed between the first substrate and the cover layer, wherein the second touch electrode layer is separated from the first touch electrode layer.

11. The touch display device according to claim 10, further comprising:
a base layer disposed between the second substrate and the cover layer, wherein the first touch electrode layer and the second touch electrode layer are disposed on the upper side and the lower side of the base layer respectively.

12. The touch display device according to claim 10, wherein the first touch electrode layer is disposed between the first substrate and the second substrate.

13. The touch display device according to claim 12, further comprising a first polarizing plate and a second polarizing plate, wherein the first substrate, the second substrate and the display medium layer are disposed between the first polarizing plate and the second polarizing plate, and the second touch electrode layer is disposed between the second polarizing plate and the second substrate.

14. The touch display device according to claim 10, further comprising a color filter layer disposed between the first substrate and the second substrate.

15. The touch display device according to claim 14, wherein the first touch electrode layer is disposed between the color filter layer and the first substrate.

16. The touch display device according to claim 14, wherein the first touch electrode layer is disposed between the color filter layer and the second substrate.

17. The touch display device according to claim 1, wherein the first substrate is a thin film transistor substrate, and the second substrate is a color filter substrate.

18. The touch display device according to claim 1, wherein the first touch electrode layer comprises a plurality of patterned electrodes.

19. The touch display device according to claim 1, wherein a material of the touch electrode layer comprises indium tin oxide, indium zinc oxide, indium tin zinc oxide, indium gallium zinc oxide, aluminum zinc oxide, aluminum zinc oxide or gallium zinc oxide.

20. The touch display device according to claim 1, wherein the cover layer is a glass layer, an adhesive layer, a polarizing plate or a hard coated layer.
